(19) United States
(12) Patent Application Publication
(10) Pub. No.: US 2025/0118306 A1
(43) Pub. Date: Apr. 10, 2025

(54) SPEECH RECOGNITION SYSTEM, SPEECH RECOGNITION METHOD, AND PROGRAM

(71) Applicant: NTT TechnoCross Corporation, Tokyo (JP)

(72) Inventors: Kenichi MACHIDA, Tokyo (JP); Kazuhira MATSUI, Tokyo (JP)

(73) Assignee: NTT TechnoCross Corporation, Tokyo (JP)

(21) Appl. No.: 18/730,283

(22) PCT Filed: Jan. 25, 2022
(86) PCT No.: PCT/JP2022/002738

§ 371 Date: Jul. 18, 2024

(51) Int. Cl. G10L 15/28; G10L 15/26

(52) U.S. Cl. CPC G10L 15/28; G10L 15/26

(57) ABSTRACT

A speech recognition system according to one embodiment includes: a speech recognition control part configured to determine whether or not to execute speech recognition on a real-time basis, on voice data that is obtained from a voice telephone call; a speech recognition part configured to execute the speech recognition on the voice data when execution of the speech recognition on a real-time basis is determined, and generate text that represents an outcome of the speech recognition; and a UI providing part configured to display a screen, on which the generated text can be referenced on a real-time basis, on a terminal connected via a communication network, and the speech recognition control part is further configured to determine, when the screen is displayed on the terminal, executing the speech recognition on a real-time basis, on voice data being a source of text that can be referenced on the screen.

### TECHNICAL FIELD

The present invention relates to a speech recognition system, a speech recognition method, and a program.

### BACKGROUND ART

For recording voices during telephone calls and converting them into text on a real-time basis, speech recognition systems for use in contact centers (also referred to as “call centers”) have long been known (see, for example, non-patent document 1). Given such speech recognition systems, voice recording g and speech recognition are generally applied to all telephone calls that take place at contact centers.

### CITATION LIST

### Non-Patent Document

Non-Patent Document 1: ForeSight Voice Mining, Internet URL: https://www.ntt-tx.co.jp/products/foresight_vm/

### SUMMARY OF INVENTION

### Technical Problem

However, speech recognition heretofore and at present is applied to telephone calls, on a real-time basis, even in cases in which real-time speech recognition is not necessarily required. For example, speech recognition is used, on a real-time basis, even when the outcomes of speech recognition are not referenced by anyone, such as when an operator does not activate the user interface (UI) for checking the outcomes of speech recognition. As a result of this, resources (especially central processing unit (CPU) resources and the like) are wasted.

An embodiment of the present invention has been prepared in view of the foregoing, and an object of the present invention is therefore to streamline the use of resources in speech recognition.

### Solution to Problem

In order to achieve the above object, the speech recognition system according to one embodiment includes: a speech recognition control part configured to determine whether or not to execute speech recognition on a real-time basis, on voice data that is obtained from a voice telephone call; a speech recognition part configured to execute the speech recognition on the voice data when execution of the speech recognition on a real-time basis is determined, and generate text that represents an outcome of the speech recognition; and a UI providing part configured to display a screen, on which the generated text can be referenced on a real-time basis, on a terminal connected via a communication network, and the speech recognition control part is further configured to determine, when the screen is displayed on the terminal, executing the speech recognition on a real-time basis, on voice data being a source of text that can be referenced on the screen.

### Advantageous Effects of Invention

According to the present invention, the use of resources in speech recognition can be streamlined.

### BRIEF DESCRIPTION OF DRAWINGS

FIG. 1 is a diagram that illustrates an example overall structure of a contact center system according to an embodiment of the present invention;

FIG. 2 is a diagram that illustrates an example of a real-time telephone call text screen;

FIG. 3 is a diagram that illustrates an example functional structure of a speech recognition system and a terminal according to the present embodiment;

FIG. 4 is a sequence diagram that illustrates an example process for starting displaying the real-time telephone call text screen according to the present embodiment;

FIG. 5 is a sequence diagram that illustrates an example process for ending the display of the real-time telephone call text screen according to the present embodiment;

FIG. 6 is a sequence diagram that illustrates an example process from the start of a telephone call to the end of the telephone call according to the present embodiment;

FIG. 7 is a sequence diagram that illustrates an example of a background speech recognition process according to the present embodiment;

FIG. 8 is a sequence diagram that illustrates an example of a search process according to the present embodiment; and

FIG. 9 is a diagram that illustrates an example of a parallel speech recognition process.

### DESCRIPTION OF EMBODIMENTS

One embodiment of the present invention will be described below. The present embodiment will presume a contact center, and describe a contact center system 1 that can streamline the use of resources (especially CPU resources and the like) when speech recognition is applied to voices recorded from operators' telephone calls. However, a contact center is simply one example, and, besides a contact center, the present invention can be used when, for example, targeting people working in an office, and trying to streamline the use of resources in speech recognition when speech recognition is applied to voices recorded from these people's telephone calls. More generally, the present invention can be applied likewise to streamline the use of resources in speech recognition when speech recognition is applied to voices recorded from certain telephone calls.

### <Overall Structure of Contact Center System 1>

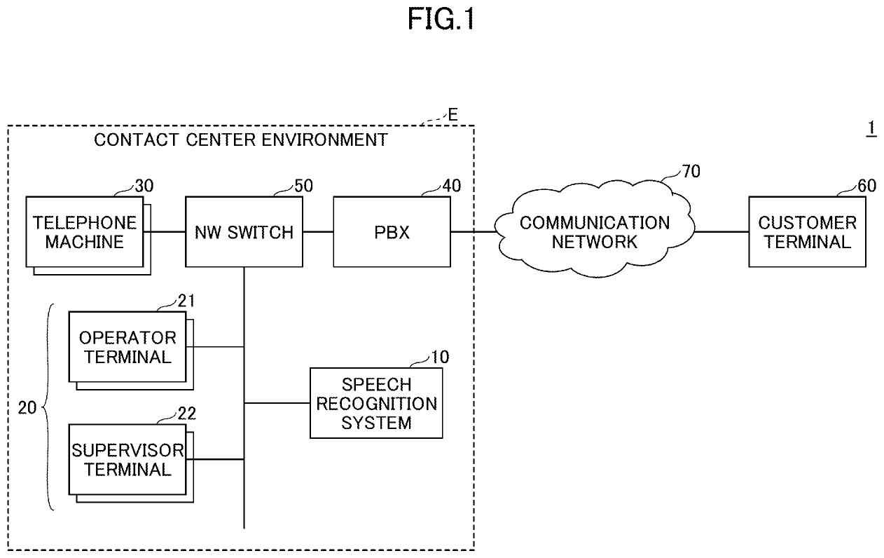

FIG. 1 shows an example overall structure of the contact center system 1 according to the present embodiment. As shown in FIG. 1, the contact center system 1 according to the present embodiment includes a speech recognition system 10, multiple terminals 20, multiple telephone machines 30, a private branch exchange (PBX) 40, a NW switch 50, and a customer terminal 60. The speech recognition system 10, terminals 20, telephone machine 30, PBX 40, and NW switch 50 are installed inside a contact center environment E, which is the contact center's system environment. Note that the contact center environment E is by no means limited to being a system environment within the same building, and may be, for example, a system environment spanning multiple buildings that are geographically separate.

For example, the speech recognition system 10 uses packets (voice packets) sent from the NW switch 50, to record the voices in a telephone call held between an operator and a customer. Also, the speech recognition system 10 applies speech recognition to the recorded voices and converts them into text (hereinafter also referred to as “telephone call text”). The speech recognition system 10, for example, executes speech recognition on the voices in the telephone call between the operator and the customer on a real-time basis, if the telephone call text is referenced by the operator or a supervisor on a real-time basis; otherwise, speech recognition is not executed on a real-time basis. Note that a supervisor refers to, for example, a person who monitors operators' telephone calls and assists the operators in performing their telephone answering duties when a problem is likely to arise, or upon request from the operators. Normally, telephone calls by several operators to several tens of operators are monitored by one supervisor.

In the following description, the screen that operators or supervisors use to reference telephone call text on a real-time basis will be referred to as a “real-time telephone call text screen.” On this real-time telephone call text screen, telephone call text, which is an outcome of speech recognition executed on a real-time basis, is displayed on a real-time basis.

A terminal 20 may refer to a variety of terminals such as a personal computer (PC) that an operator or a supervisor can use. In the following description, a terminal 20 for an operator's use will be referred to as an “operator terminal 21,” and a terminal 20 for a supervisor's use will be referred to as a “supervisor terminal 22.”

A telephone machine 30 is an Internet protocol (IP) telephone machine (a fixed IP telephone machine, a portable IP telephone machine, etc.) for an operator's use. Note that, generally, one operator terminal 21 and one telephone machine 30 are installed at an operator's seat.

The PBX 40 is a private branch exchange (IP-PBX) that is connected to a communication network 70, which may be a voice over Internet protocol (VOIP) network, a public switched telephone network (PSTN), or the like.

The NW switch 50 relays packets between the telephone machine 30 and the PBX 40, captures the packets, and sends them to the speech recognition system 10.

A customer terminal 60 may be a variety of terminals that a customer can use, such as a smartphone, a mobile phone, a landline telephone, and so forth.

Note that the overall structure of the contact center system 1 shown in FIG. 1 is an example, and other structures may be used as well. For example, in the example shown in FIG. 1, the PBX 50 is an on-premises private branch exchange, but the PBX 40 may be implemented by a cloud service as well. Also, for example, the speech recognition system 10 may be implemented by one server and referred to as a “speech recognition device.” Furthermore, when the operator terminal 21 also functions as an IP telephone machine, the operator terminal 21 and the telephone machine 30 may be structured as one entity.

### <Real-Time Telephone Call Text Screen>

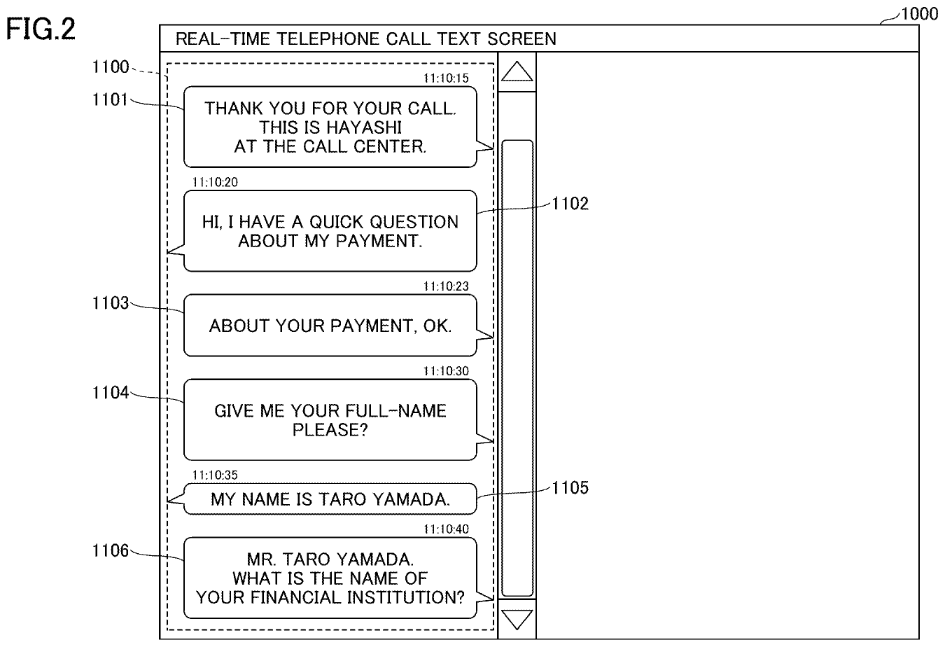

An example of the real-time telephone call text screen is shown in FIG. 2. The real-time telephone call text screen 1000 shown in FIG. 2 includes a real-time telephone call text display part 1100. Every time the speech recognition system 10 executes speech recognition on a real-time basis, the telephone call text obtained by that speech recognition is displayed in the real-time telephone call text display part 1100, on a real-time basis (in other words, telephone call text obtained through speech recognition is quickly displayed on the real-time telephone call text display part 1100).

For example, in the example shown in FIG. 2, telephone call text 1101 to telephone call text 1106 are displayed in the real-time telephone call text display part 1100.

By this means, the operator and supervisor can check what talk an operator and a customer engaged in an on-going telephone call are having, on a real-time basis, by looking at the real-time telephone call text screen.

### <Functional Structure of Speech Recognition System 10 and Terminal 20>

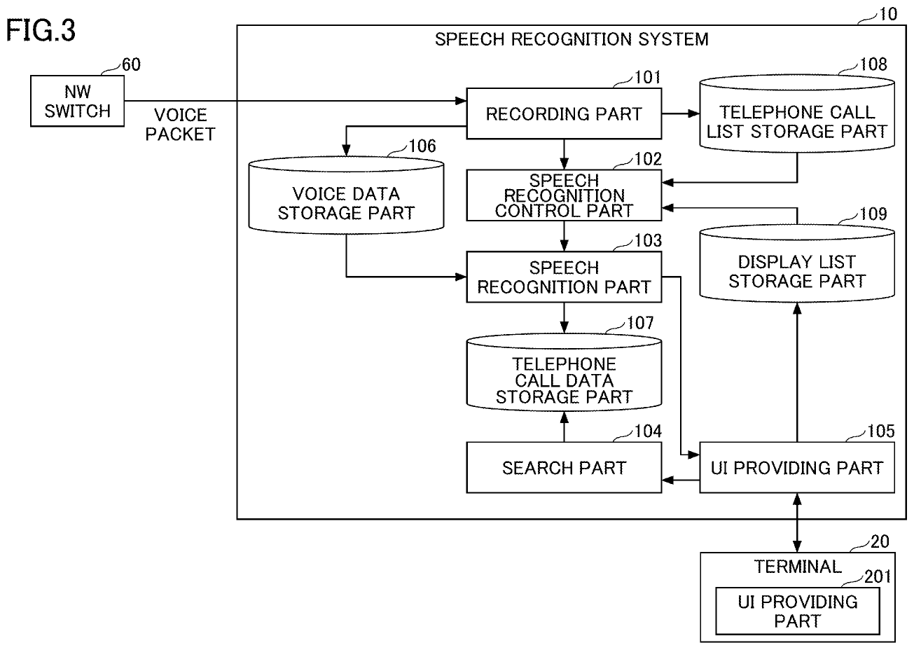

FIG. 3 shows an example functional structure of the speech recognition system 10 and a terminal 20 according to the present embodiment.

### <<Speech Recognition System 10>>

As shown in FIG. 3, the speech recognition system 10 according to the present embodiment includes a recording part 101, a speech recognition control part 102, a speech recognition part 103, a search part 104, and a UI providing part 105. These parts are implemented, for example, by a process executed on a processor such as a central processing unit (CPU) by one or more programs installed in the speech recognition system 10. Also, the speech recognition system 10 according to the present embodiment includes a voice data storage part 106, a telephone call data storage part 107, a telephone call list storage part 108, and a display list storage part 109. Each of these storage parts can be implemented by, for example, a secondary storage device such as a hard disk drive (HDD), a solid state drive (SSD), and so forth. Note that at least some of these storage parts may be implemented by, for example, a storage device or the like that is connected to the speech recognition system 10 via a communication network.

The recording part 101 records, for example, the voice data contained in a voice packet sent from the NW switch 50. That is, the recording part 101 stores the voice data contained in the voice packet in the voice data storage part 106 in association with a telephone call ID. Note that the telephone call ID refers to information that uniquely identifies a telephone call held between an operator and a customer.

Also, when a telephone call starts between an operator and a customer, the recording part 101 adds a pair of user IDs, that is, the user ID of the operator making this telephone call and the telephone call ID of this telephone call, to a telephone call list. Furthermore, when the telephone call ends, the recording part 101 removes this pair of the user ID of the operator who made the telephone call and the telephone call ID of the telephone call, from the telephone call list. Here, the telephone call list refers to a list in which the user IDs of operators engaged in on-going telephone calls and the telephone call IDs of these telephone calls are stored in pairs. Note that the user ID refers to information that uniquely identifies an operator (and his/her supervisor).

The speech recognition control part 102 controls whether or not to apply speech recognition to a telephone call between an operator and a customer on a real-time basis (that is, whether or not to execute speech recognition on a real-time basis). In other words, when a telephone call's telephone call text is displayed on the real-time telephone call text screen on a real-time basis, the speech recognition control part 102 executes speech recognition on the voices in that telephone call on a real-time basis. When a telephone call's telephone call text is not displayed on the real-time telephone call text screen on a real-time basis, the speech recognition control part 102 does not execute speech recognition on a real-time basis; instead, the speech recognition control part 102 controls speech recognition to be executed in the background at some timing. Then, if the CPU resources and the like run short when applying speech recognition to the voices of a new telephone call on a real-time basis, the speech recognition control part 102 controls speech recognition such that the speech recognition in the background is cancelled partly or entirely and the speech recognition in real time is executed preferentially.

The speech recognition part 103 executes speech recognition on the voice data and generates telephone call text, under the control of the speech recognition control part 102. Also, the speech recognition part 103 generates telephone call data that includes at least a telephone call ID and telephone call text, and stores the telephone call data in the telephone call data storage part 107.

The search part 104 searches for telephone call data stored in the telephone call data storage part 107, based on search conditions received from the UI providing part 105.

The UI providing part 105 provides the terminal 20 with information (hereinafter also referred to as “UI information”) for displaying user interfaces (UIs) on various screens (for example, the real-time telephone call text screen, a search screen that allows the user to specify the above search conditions, etc.) on the terminal 20. Note that the UI information may refer to any information that is necessary to display screens, such as screen-defining information in which the screen to be displayed is defined in hypertext markup language (HTML) or the like.

Also, when the UI providing part 105 receives a request for displaying the real-time telephone call text screen from the terminal 20, the UI providing part 105 adds the pair of user IDs, included in the display request, to a display list. Furthermore, when the display of the real-time telephone call text screen ends, the UI providing part 105 removes the pair of user IDs, included in the notice of end, from the display list. Here, the display list refers to a list in which the user ID of operators engaged in telephone calls in which the telephone call text is displayed on a real-time telephone call text screen on a real-time basis, and the user IDs of users (operators or supervisors) of terminals 20 on which that real-time telephone call text screen is displayed, are stored in pairs.

The voice data storage part 106 stores the voice data recorded by the recording part 101.

The telephone call data storage part 107 stores the telephone call data. The telephone call data at least includes the telephone call ID and the telephone call text. In addition to these, the telephone call data may also contain a variety of other information such as, for example, the source telephone number and the destination telephone number pertaining to the telephone call of the telephone call ID, the user ID of the operator who made the telephone call, the time the telephone call started, the time the telephone call ended, and so forth.

The telephone call list storage part 108 stores a telephone call list, in which the user IDs of operators engaged in on-going telephone calls and the telephone call IDs of these telephone calls are stored in pairs.

The display list storage part 109 stores a display list, in which the user IDs of operators engaged in telephone calls in which the telephone call text is displayed on the real-time telephone call text screen on a real-time basis and the user IDs of the operators of the terminals 20 on which that real-time telephone call text screen is displayed are stored in pairs.

### <<Terminal 20>>

As shown in FIG. 3, the terminal 20 according to the present embodiment has a UI part 201. The UI part 201 is implemented by, for example, one or more programs that are installed in the terminals 20 and executed by a processor such as a CPU.

The UI part 201 displays various screens (for example, the real-time telephone call text screen, the search screen, etc.) on a display or the like based on UI information provided from the UI providing part 105 of the speech recognition system 10. Also, the UI part 201 accepts various operations performed on the screens displayed on the display or the like.

<Process in contact center system 1>

Below, various processes executed by the contact center system 1 according to the present embodiment will be described.

### <<Process for Starting Displaying Real-Time Telephone Call Text Screen>>

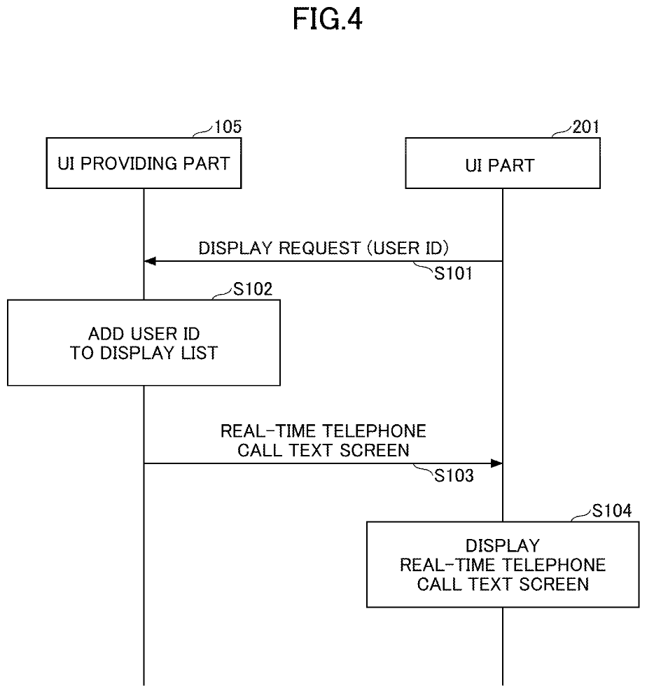

The process for starting displaying the real-time telephone call text screen according to the present embodiment will be described with reference to FIG. 4. In the following description, a case will be described in which a certain user (operator or supervisor) displays the real-time telephone call text screen on the display of his/her terminal 20.

Note that, if the real-time telephone call text screen is not displayed, the real-time telephone call text screen can be displayed at any timing (that is, this process can be started for execution at any timing). Thus, for example, if the user wants to display a real-time telephone call text screen, on which the telephone call text of a certain operator's telephone call is displayed on a real-time basis, on his/her terminal 20, the user (the operator himself/herself or the supervisor monitoring the operator's telephone call) can display the real-time telephone call text screen before the telephone call starts, or display the real-time telephone call text screen during the telephone call.

First, in response to an operation for displaying the real-time telephone call text screen, the UI part 201 of the terminal 20 sends a request for displaying the real-time telephone call text screen to the speech recognition system 10 (step S101). The display request includes the user ID of the operator (hereinafter also referred to as “display target user ID”), whose telephone call text is to be displayed on the real-time telephone call text screen on a real-time basis, and the user ID of the user using the terminal 20 that sent the display request (hereinafter also referred to as “display user ID”). Note that, if the terminal 20 is an operator terminal 21, the display target user ID and the display user ID are the user IDs of the operator using that operator terminal 21. On the other hand, if the terminal 20 is a supervisor terminal 22, the display target user ID is the user ID of the certain operator monitored by the supervisor terminal 22, and the display user ID is the user ID of the supervisor using that supervisor terminal 22.

When the request for displaying the real-time telephone call text screen arrives, the UI providing part 105 adds the display target user ID and display user ID, included in the display request, to the display list (step S102).

Next, the UI providing part 105 of the speech recognition system 10 sends UI information for the real-time telephone call text screen to the terminal 20 (step S103).

Upon receiving the UI information for the real-time telephone call text screen, the UI part 201 of the terminal 20 displays the real-time telephone call text screen on the display based on the UI information (step S104).

### <<Process for Ending Display of Real-Time Telephone Call Text Screen>>

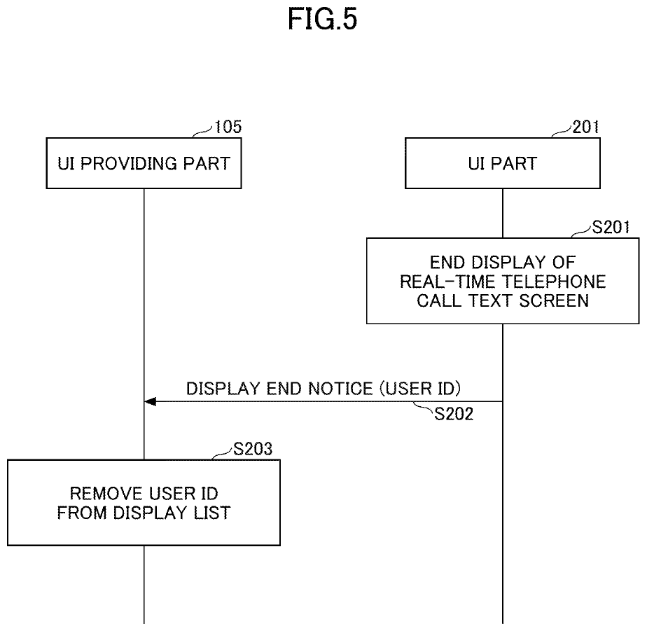

The process for ending the display of the real-time telephone call text screen according to the present embodiment will be described with reference to FIG. 5. In the following description, a case will be described in which a certain user (operator or supervisor) ends the display of the real-time telephone call text screen that is displayed on the display of his/her terminal 20.

Note that, if the real-time telephone call text screen is displayed, the display of the real-time telephone call text screen can be ended at any timing (that is, this process can be started for execution at any timing). Therefore, for example, if the real-time telephone call text screen, on which the telephone call text of a certain operator's telephone call is displayed on a real-time basis, is displayed on a terminal 20, the user (the operator himself/herself or the supervisor monitoring the operator's telephone call) can end the display of the real-time telephone call text screen during the telephone call, or end the display of the real-time telephone call text screen after the telephone call ends.

First, in response to an operation for ending the display of the real-time telephone call text screen, the UI part 201 of the terminal 20 ends the display of the real-time telephone call text screen (step S201).

Next, the UI part 201 of the terminal 20 sends a display end notice to the speech recognition system 10 (step S202). Here, the display end notice includes a display target user ID and a display user ID. Note that, if the terminal 20 is an operator terminal 21, the display target user ID and the display user ID are the user IDs of the operator using that operator terminal 21. On the other hand, if the terminal 20 is a supervisor terminal 22, the display target user ID is the user ID of the certain operator monitored by the supervisor terminal 22, and the display user ID is the user ID of the supervisor using that supervisor terminal 22.

Upon receiving the display end notice, the UI providing part 105 of the speech recognition system 10 removes the display target user ID and display user ID, included in the display end notice, from the display list (step S203).

<<Process from Start of Telephone Call to End of Telephone Call>>

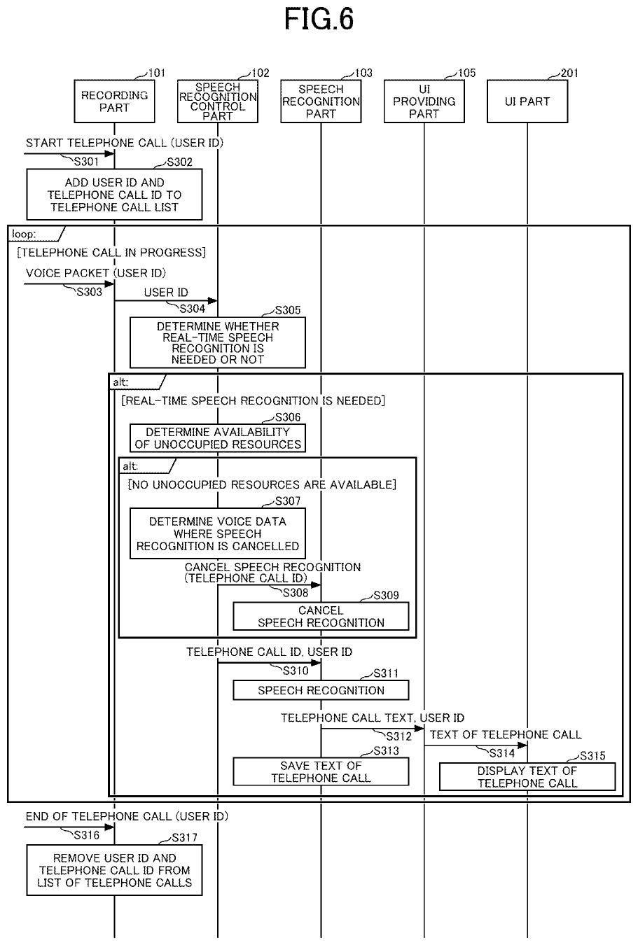

The process from the start of a telephone call to the end of the telephone call according to the present embodiment will be described with reference to FIG. 6. Below, the process from the start of a certain operator's telephone call to the end of the telephone call will be described.

First, the recording part 101 of the speech recognition system 10 receives a telephone call starting packet from the NW switch 50 (step S301).

Next, the recording part 101 of the speech recognition system 10 adds the user ID (hereinafter also referred to as “calling user ID”), included in the telephone call starting packet, and the telephone call ID of the telephone call that is started, to the telephone call list (step S302). Note that the recording part 101 can generate telephone call IDs in any manner as desired; however, given that one operator can make only one telephone call at a time, a telephone call's telephone call ID may be generated by, for example, adding the date and time the telephone call started, to the calling user ID of the telephone call.

The following steps S303 to S315 are repeated during the telephone call (that is, until the recording part 101 receives a telephone call end packet). Below, steps S303 to S315 in one repetition will be described.

The recording part 101 of the speech recognition system 10 receives a voice packet from the NW switch 50 (step S303). Here, the voice packet includes the voice data and the user ID (calling user ID). The recording part 101 specifies the telephone call ID that matches the calling user ID from the telephone call list, and then saves the voice data in the voice data storage part 106 in association with the telephone call ID specified.

The recording part 101 of the speech recognition system 10 sends the calling user ID included in the voice packet received from the NW switch 50, to the speech recognition control part 102 (step S304).

When the speech recognition control part 102 of the speech recognition system 10 receives the calling user ID, the speech recognition control part 102 determines whether or not it is necessary to execute speech recognition on the voice data of the telephone call ID matching the calling user ID in the telephone call list, on a real-time basis (step S305). To be more specific, the speech recognition control part 102 determines whether the calling user ID is included as a display target user ID in the display list. Then, if the calling user ID is included as a display target user ID in the display list, the speech recognition control part 102 determines that speech recognition needs to be executed on the voice data of the telephone call ID matching the calling user ID in the telephone call list on a real-time basis; otherwise, the speech recognition control part 102 determines that there is no need to execute speech recognition on that voice data on a real-time basis. Note that, if the calling user ID is included as a display target user ID in the display list, this means that the telephone call text of the telephone call by the operator of the calling user ID is referenced on the real-time telephone call text screen on a real-time basis.

If, in the above step S305, it is determined that speech recognition needs to be executed on a real-time basis, the following steps S306 to S315 are executed.

The speech recognition control part 102 of the speech recognition system 10 determines whether or not unoccupied resources (especially CPU resources and the like) that can be used for speech recognition are available (step S306). Here, the resources that can be used for speech recognition are often represented by an index value that is referred to as “multiplicity,” which indicates the number or amount of voice data that can be speech-recognized simultaneously. For example, if the multiplicity is N, this means that N pieces of voice data can be speech-recognized at the same time. Therefore, for example, assuming that the number or amount of voice data that is speech-recognized simultaneously at present is n and that the multiplicity is N, the speech recognition control part 102 can determine that unoccupied resources are available when n<N holds, and, otherwise, determine that no unoccupied resources are available.

If it is determined in the above step S306 that no unoccupied resources are available, the following steps S307 to S309 are executed.

The speech recognition control part 102 of the speech recognition system 10 selects the voice data for which speech recognition is cancelled, among the voice data stored in the voice data storage part 106, according to steps 1 to 3 below (step S307).

### Step 1:

The speech recognition control part 102 specifies the voice data that is currently undergoing speech recognition, among the voice data stored in the voice data storage part 106.

### Step 2:

Next, among the voice data specified in step 1, the speech recognition control part 102 specifies voice data other than the voice data that is undergoing real-time speech recognition. Here, the calling user IDs included as display target user IDs in the display list may be specified, and the telephone call IDs corresponding to these calling user IDs may be specified in the telephone call list, thereby specifying the voice data having telephone call IDs that are associated with calling user IDs as the voice data that is undergoing real-time speech recognition.

### Step 3:

Then, the speech recognition control part 102 selects one or more pieces of voice data, among the voice data specified in step 2, as the voice data for which speech recognition is cancelled. Note that speech recognition may be cancelled with respect to a single piece of voice data or with respect to multiple pieces of voice data. Also, the voice data for which speech recognition is cancelled may be selected randomly from among the voice data specified in step 2, or may be selected according to certain rules. Examples of these rules may include, for example, selecting voice data that has lasted a shorter (or a longer) period of time since the start of speech recognition preferentially, selecting the voice data of a telephone call by a certain operator (or an operator belonging to a certain group) preferentially, selecting voice data based on a round-robin approach, and so forth.

The speech recognition control part 102 of the speech recognition system 10 sends, to the speech recognition part 103, the telephone call ID associated with the voice data for cancelling speech recognition, selected in step S307 (step S308).

The speech recognition part 103 of the speech recognition system 10 cancels speech recognition with respect to the voice data associated with the telephone call ID received from the speech recognition control part 102 (step S309). This gives unoccupied resources that are available for use in speech recognition.

In the event it is determined in the above step S306 that unoccupied resources are available, or following the above step S309, the speech recognition control part 102 of the speech recognition system 10 specifies the telephone call ID corresponding to the calling user ID sent from the recording part 101 in the above step S304 in the telephone call list, and sends the specified telephone call ID and the matching calling user ID, to the speech recognition part 103 (step S310).

The speech recognition part 103 of the speech recognition system 10 executes speech recognition on the voice data associated with the telephone call ID received from the speech recognition control part 102 (step S311). By this means, telephone call text, which is produced as an outcome of speech recognition applied to that voice data, can be generated.

Note that, for example, during a telephone call, a certain terminal 20 may display the real-time telephone call text screen so as to allow the telephone call text of that telephone call to be referenced. In this case, there may be no telephone call text before the real-time telephone call text screen is displayed. To illustrate a specific example, assuming that a telephone call starts at a time tₛ, if the real-time telephone call text screen for referencing the telephone call text of that telephone call is displayed at a time t (>tₛ), there may be no telephone call text from time tₛ to t. In this case, in step S311 described above, the speech recognition part 103 may perform speech recognition not only on the voice data after time t but also on past voice data (that is, for example, the voice data from time tₛ to t) at the same time.

The speech recognition part 103 of the speech recognition system 10 sends the telephone call text generated in step S311 above, and the calling user ID received from the speech recognition control part 102 in step S310 above, to the UI providing part 105 (step S312).

Also, the speech recognition part 103 of the speech recognition system 10 associates the telephone call text generated in step S311, with the telephone call ID, and stores the resulting telephone call data in the telephone call data storage part 107 (step S313). Note that, when this takes place, various information such as the calling user ID may be included in the telephone call data.

When the UI providing part 312 of the speech recognition system 10 receives the telephone call text and the calling user ID, the UI providing part 312 specifies a display user ID, which corresponds to the display target user ID that matches the calling user ID, in the display list, and sends the telephone call text to the terminals 20 having specified the display user ID (step S314).

When the UI part 201 of the terminal 20 receives the telephone call text from the speech recognition system 10, the UI part 201 displays the telephone call text on the real-time telephone call text screen (step S315). By this means, the telephone call text is displayed on the real-time telephone call text screen on a real-time basis.

When a telephone call end packet is sent from the NW switch 50, the recording part 101 of the speech recognition system 10 receives the telephone call end packet from the NW switch 50 (step S316).

Then, the recording part 101 of the speech recognition system 10 removes the calling user ID that matches the user ID included in the telephone call end packet, and the corresponding telephone call ID, from the telephone call list (step S317).

### <<Background Speech Recognition Process>>

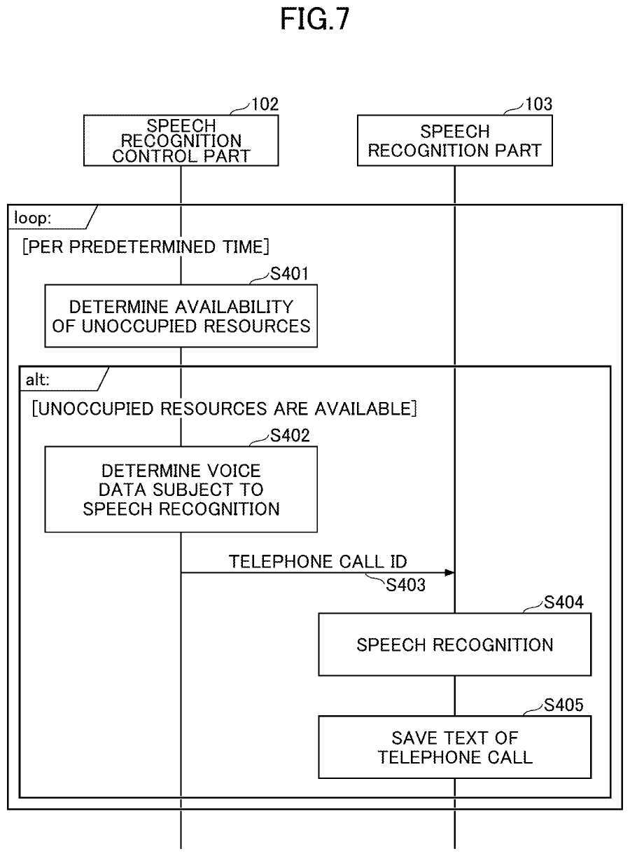

The background speech recognition process according to the present embodiment will be described with reference to FIG. 7. This background speech recognition process refers to a process of executing speech recognition on voice data other than the voice data subject to real-time speech recognition. The background speech recognition process is repeated at predetermined intervals of time (for example, every 10 minutes), in the background of the “process for starting displaying the real-time telephone call text screen,” “process for ending displaying the real-time telephone call text screen,” and “process from the start of a telephone call to the end of the telephone call,” all described earlier herein. However, the time interval for repeating the background speech recognition process may vary depending on, for example, the time of the day, and the like. For example, during daytime hours when the volume of telephone calls is large, the time interval for repetition may be made longer so that more real-time speech recognition can be executed, and, during nighttime hours when the volume of telephone calls is low, the time interval for repetition may be made shorter so that more background speech recognition can be executed. Alternatively, the background speech recognition process may not be executed during daytime hours when the volume of telephone calls is large, so that more real-time speech recognition can be executed.

First, as in step S306 of FIG. 6, the speech recognition control part 102 of the speech recognition system determines whether or not unoccupied resources (especially CPU resources and the like) that can be used for speech recognition are available (step S401).

If it is determined in the above step S401 that no unoccupied resources are available, the following steps S402 to S404 are executed.

The speech recognition control part 102 of the speech recognition system 10 selects the voice data for executing speech recognition, among the voice data stored in the voice data storage part 106, according to steps 11 and 12 below (step S402).

### Step 11:

The speech recognition control part 102 specifies voice data that is not currently undergoing speech recognition, among the voice data stored in the voice data storage part 106.

### Step 12:

Then, among the voice data specified in step 11, the speech recognition control part 102 selects one or more pieces of voice data as voice data to execute speech recognition on. Note that speech recognition may be executed on a single piece of voice data or on multiple pieces of voice data, depending on the availability of unoccupied resources that can be used for speech recognition. Also, the voice data for executing speech recognition may be selected randomly from among the voice data specified in step 11, or may be selected according to certain rules. Examples of these rules may include, for example, selecting voice data that has lasted a longer (or a shorter) period of time since the start of speech recognition preferentially, selecting the voice data of a telephone call by a certain operator (or an operator belonging to a certain group) preferentially, selecting voice data based on a round-robin approach, and so forth.

The speech recognition control part 102 of the speech recognition system 10 sends, to the speech recognition part 103, the telephone call ID associated with the voice data for executing speech recognition, selected in step S402 (step S403).

The speech recognition part 103 of the speech recognition system 10 executes speech recognition on the voice data associated with the telephone call ID received from the speech recognition control part 102 (step S404). By this means, telephone call text, which is produced as a outcome of applying speech recognition to that voice data, can be generated.

The speech recognition part 103 of the speech recognition system 10 associates the telephone call text generated in step S404 with the telephone call ID, and stores the resulting telephone call data in the telephone call data storage part 107 (step S405). Note that, when this takes place, various information such as the user ID of the operator who made the telephone call of this telephone call ID may be included in the telephone call data.

### <<Search Process>>

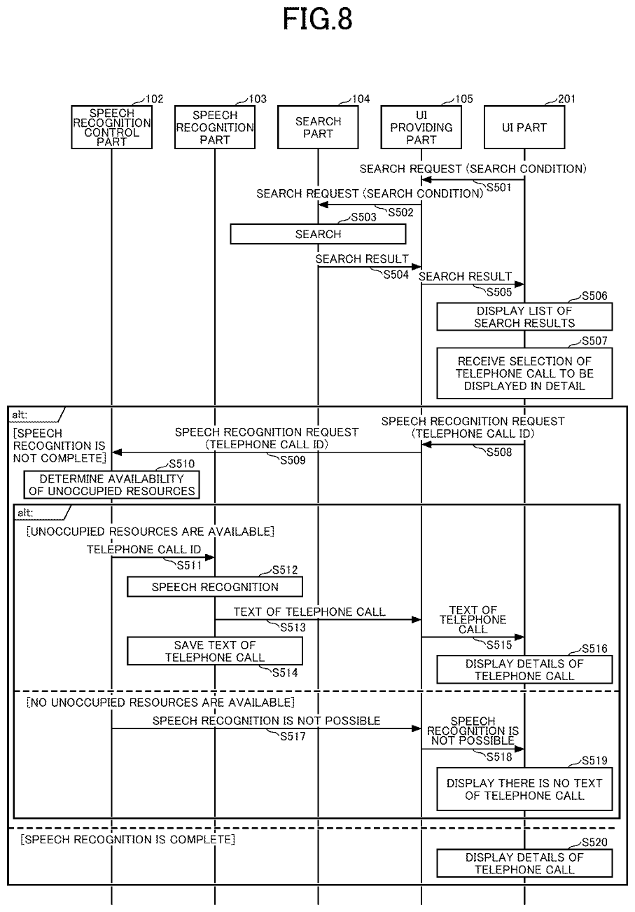

The search process according to the present embodiment will be described with reference to FIG. 8. In the following description, a case will be described in which a certain user (operator or supervisor) searches for telephone call data by using his/her own terminal 20.

Note that the search for telephone call data can be made at any timing (that is, this process can be started for execution at any timing).

The UI part 201 of the terminal 20 sends a search request, including search conditions specified by the user, to the speech recognition system 10 (step S501). Here, the search conditions may be any condition specified for searching for telephone call data, and, for example, a user ID, the data and time a telephone call started, the date and time a telephone call ended, the duration of a telephone call, and so forth can be specified as search conditions. Note that the user can, for example, specify these search conditions on a search screen for specifying search conditions.

Upon receiving the search request from the terminals 20, the UI providing part 105 of the speech recognition system 10 sends the search request to the search part 104 (step S502).

When the search part 104 of the speech recognition system 10 receives the search request from the UI providing part 105, the search part 104 searches the telephone call data stored in the telephone call data storage part 107 based on the search conditions included in the search request (step S503).

The search part 104 of the speech recognition system 10 sends the search results obtained in step S503 above, to the UI providing part 105 (step S504). Note that the search results may include, for example, the telephone call data searched in step S503 above.

Upon receiving the search results from the search part 104, the UI providing part 105 of the speech recognition system 10 sends the search results to the terminal 20 (step S505).

When the UI part 201 of the terminal 20 receives the search results from the speech recognition system 10, the UI part 201 displays a search result list, which is a list of telephone call data included in the search results (step S506). Given this search result list, the user can select the telephone call data that he/she desires to display in detail. Note that this list of search results may be displayed on the search screen, or may be displayed on a screen that is different from the search screen.

The UI part 201 of the terminal 20 accepts the selection of telephone call data to be displayed in detail in the search result list (step S507).

Here, if speech recognition has been completed with respect to the voice data of the telephone call represented by the telephone call data selected by the user, the telephone call data includes telephone call text that represents the entire telephone call. On the other hand, if speech recognition has not been completed with respect to the voice data of the telephone call represented by the telephone call data selected by the user, the telephone call data includes no telephone call text, or includes telephone call text that represents only a part of the telephone call. Therefore, if speech recognition has not been completed with respect to the voice data of the telephone call represented by the telephone call data selected by the user, the following steps S508 to S519 are executed; otherwise, the following step S520 is executed. Note that whether or not telephone call text represents only a part of a telephone call can be determined from, for example, the duration of the telephone call.

The UI part 201 of the terminal 20 sends a speech recognition request to the speech recognition system 10 (step S508). Here, the speech recognition request includes the telephone call ID of the telephone call data selected by the user.

When the UI providing part 105 of the speech recognition system 10 receives the speech recognition request from the terminals 20, the UI providing part 105 sends the speech recognition request to the speech recognition control part 102 (step S509).

As in step S306 of FIG. 6, the speech recognition control part 102 of the speech recognition system 10 determines whether or not unoccupied resources (especially CPU resources and the like) that can be used for speech recognition are available (step S510).

If it is determined in the above step S510 that unoccupied resources are available, the following steps S511 to S516 are executed.

The speech recognition control part 102 of the speech recognition system 10 sends the telephone call ID included in the speech recognition request received from the UI providing part 105, to the speech recognition part 103 (step S511).

The speech recognition part 103 of the speech recognition system 10 executes speech recognition on the voice data associated with the telephone call ID received from the speech recognition control part 102 (step S512). By this means, telephone call text, which is produced as an outcome of speech recognition applied to that voice data, can be generated.

The speech recognition part 103 of the speech recognition system 10 sends the telephone call text generated in step S512 above, to the UI providing part 105 (step S513).

Also, the speech recognition part 103 of the speech recognition system 10 associates the telephone call text generated in step S512, with the telephone call ID, and stores the resulting telephone call data in the telephone call data storage part 107 (step S514). Note that, when this takes place, various information such as the calling user ID may be included in the telephone call data.

When the UI providing part 105 of the speech recognition system 10 receives the telephone call text from the speech recognition part 103, the UI providing part 105 sends the telephone call text to the terminals 20 where the speech recognition request came from (step S515).

When the UI part 201 of the terminal 20 receives the telephone call text from the speech recognition system 10, the UI part 20 displays the details of the telephone call, including the telephone call text (step S516). Note that the details of the telephone call may be displayed on the search screen or on a different screen that is different from the search screen.

On the other hand, if it is determined in the above step S510 that no unoccupied resources are available, the following steps S517 to S519 are executed.

The speech recognition control part 102 of the speech recognition system 10 sends information indicating that speech recognition is not possible, to the UI providing part 105 (step S517).

When the UI providing part 105 of the speech recognition system 10 receives the information indicating that speech recognition is not possible, from the speech recognition control part 102, the UI providing part 105 sends this information to the terminal 20 where the speech recognition request came from (step S518).

When the UI part 201 of the terminal 20 receives the information indicating that speech recognition is not possible, from the speech recognition system 10, the UI part 201 displays information indicating that there is no telephone call text (step S519). However, the UI part 201 may display information other than telephone call text (for example, the telephone call ID, user ID, user name, etc.).

If speech recognition has been completed with respect to the voice data of the telephone call represented by the telephone call data selected by the user, the UI part 201 of the terminal 20 displays the details of the telephone call in the same manner as in step S516 above (step S520).

### <Parallel Speech Recognition Process>

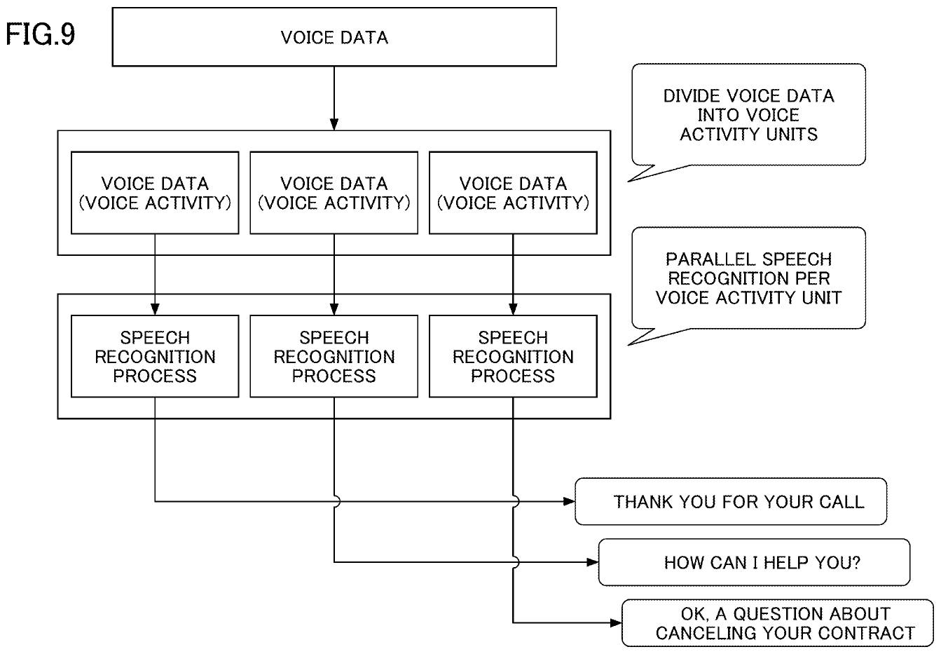

Now, assuming that a telephone call is in progress and a real time telephone call text screen for referencing the telephone call text of the telephone call is displayed, speech recognition may be executed on past voice data at the same time. However, generally, the speech recognition process takes approximately the same amount of time as the actual duration of talk, and a certain amount of time is required before the user is able to reference the telephone call text of past voice data. Also, for example, since a certain amount of time is required until the telephone call text is generated in step S512 of FIG. 9, the user who displays the details of the telephone call data may experience a waiting time.

Therefore, a method for shortening the time required to generate telephone call text by executing speech recognition in parallel will be described below. This method enables the speech recognition part 103 to generate telephone call text in a shorter time.

For example, when applying speech recognition to certain voice data based on this method, the voice data is first divided into segments referred to as “voice activities,” as shown in FIG. 9. The voice activities can be detected by a process referred to as “voice activity detection (VAD).” That is, according to this method, as shown in FIG. 9, speech recognition is performed, in parallel, in units of voice activities. By this means, since speech recognition is executed in parallel on a per voice activity basis, it is possible to obtain telephone call text for the original voice data in a shorter time. Note that voice activity detection (VAD) can be executed with very little CPU resources, compared to the speech recognition process, so that, even if voice activity detection is performed in advance, this has substantially no impact on the resources for the speech recognition system 10.

### SUMMARY

As described above, according to the contact system 1 of the present embodiment, speech recognition is executed preferentially for the voice data of a telephone call if the user (operator, supervisor, etc.) references the telephone call text of the telephone call on a real-time basis, whereas, if the user does not reference the telephone call text of the telephone call on a real-time basis, speech recognition therefor is performed in the background if unoccupied resources are available (or during hours when unoccupied resources are available, such as nighttime hours). By this means, the resources for the speech recognition system 10 can be used efficiently. Consequently, if, for example, some cost is incurred depending on the multiplicity N of the speech recognition system 10 (for example, when the speech recognition system 10 is implemented by a virtual machine on a remote cloud server and cost is incurred depending on the number of CPU cores of the virtual machine), that cost can be reduced.

The present invention is by no means limited to the embodiment described in detail herein, and a variety of alterations and changes, and combinations with existing techniques, and so forth are possible without departing from the scope of the claims attached herewith.

### REFERENCE SIGNS LIST

1 contact center system
10 speech recognition system
20 terminal
21 operator terminal
22 supervisor terminal
30 telephone machine
40 PBX
50 NW switch
60 customer terminal
70 communication network
101 recording part
102 speech recognition control part
103 speech recognition part
104 search part
105 UI providing part
106 voice data storage part
107 telephone call data storage part
108 telephone call list storage part
109 display list storage part
201 UI part

1. A speech recognition system comprising:
at least one processor; and
memory storing instructions that, when executed by the at least one processor, cause the speech recognition system to perform operations, the operations comprising:
determining whether to execute speech recognition on a real-time basis, on voice data, wherein the voice data is obtained from a voice telephone call;
executing, the speech recognition on the voice data when a result of the determining whether to execute speech recognition indicates execution of the speech recognition on a real-time basis; and
generating text that represents an outcome of the speech recognition;
displaying a screen, wherein the generated text is referenced on a real-time basis, from a terminal connected to the speech recognition system via a communication network; and
when the screen is displayed on the terminal, executing the speech recognition on a real-time basis, on voice data, wherein the voice data represents a source of text referenced on the screen.

2. The speech recognition system according to claim 1, wherein the operations further comprises:
determining, at predetermined intervals of time, whether a computing resource is available for use for the speech recognition, and, when the unoccupied resources are available, executing the speech recognition on voice data, wherein the result of the determining whether to execute the speech recognition indicates the speech recognition on a non-real-time basis, and
executing the speech recognition on the voice data, for which the execution of the speech recognition on a real-time basis has not been determined, and generating text that represents an outcome of the speech recognition.

3. The speech recognition system according to claim 2, wherein the set of operations further comprises:
selecting, randomly or according to predetermined rules, one or more pieces of voice data for executing the speech recognition, from among the voice data, for which the execution of the speech recognition on a real-time basis has not been determined; and
executing the speech recognition on the one or more pieces of voice data selected, and generate text that represents an outcome of the speech recognition.

4. The speech recognition system according to claim 2, wherein the set of operations further comprises:
when the speech recognition is determined to be executed on voice data on a real-time basis, determining whether or not the unoccupied resources are available;
when the unoccupied resources are not available, selecting one or more pieces of voice data, for which the speech recognition is cancelled, among the voice data, for which the execution of the speech recognition on a real-time basis has not been determined; and
cancelling the speech recognition for the selected one or more pieces of voice data, for which the speech recognition is cancelled.

5. The speech recognition system according to claim 4, wherein the set of operations further comprises selecting, when the unoccupied resources are not available, the one or more pieces of voice data, for which the speech recognition is cancelled, among the voice data, for which the execution of the speech recognition on a real-time basis has not been determined, randomly or according to predetermined rules.

6. The speech recognition system according to claim 1, wherein the set of operations further comprises displaying the screen on one or both of a terminal that a first user engaged in the voice telephone call uses, and a terminal that a second user monitoring the voice telephone call of the first user uses.

7. The speech recognition system according to claim 1, wherein the set of operations further comprises:
storing telephone call data related to the voice telephone call;
searching for telephone call data stored in the storage part based on search conditions specified by the terminal and;
executing, when the searched telephone call data is displayed on the terminal and the speech recognition has not been completed with respect to voice data corresponding to the searched telephone call data, the speech recognition on the voice data.

8. The speech recognition system according to claim 1, wherein the set of operations further comprises dividing the voice data into predetermined voice activity units and executing the speech recognition, in parallel, per voice activity unit.

9. A speech recognition method to be executed on a computer, the method comprising:
determining whether or not to execute speech recognition on a real-time basis, on voice data that is obtained from a voice telephone call;
executing the speech recognition on the voice data when execution of the speech recognition on a real-time basis is determined, and generating text that represents an outcome of the speech recognition;
displaying a screen, on which the generated text can be referenced on a real-time basis, on a terminal connected via a communication network; and
determining, when the screen is displayed on the terminal, executing the speech recognition on a real-time basis, on voice data being a source of text that can be referenced on the screen.

10. A computer-readable non-transitory recording medium storing a program that, when executed on a computer, causes the computer to perform the speech recognition method of claim 9.
